(19) United States
(12) Patent Application Publication
(10) Pub. No.: US 2006/0118132 A1
(43) Pub. Date: Jun. 8, 2006

(54) Cleaning with electrically charged aerosols

(76) Inventors: Eric J. Bergman, Kalispell, MT (US); Dana R. Scranton, Kalispell, MT (US); Brian Aegerter, Kalispell, MT (US)

Correspondence Address: PERKINS COIE LLP/SEMITOOL, PO BOX 1208, SEATTLE, WA, 98111-1208, US

(21) Appl. No.: 11/005,553

(22) Filed: Dec. 6, 2004

(51) Int. Cl. B08B 3/12; B08B 3/00

(52) U.S. Cl. 134/1; 134/34; 134/94.1; 134/198; 134/137; 134/149

(57) ABSTRACT

In a method for cleaning a wafer, the wafer is placed a processing chamber. A layer or film of liquid is provided on the wafer. Electrically charged aerosol droplets of a liquid are formed and directed to the workpiece. The charged aerosol particles accumulate on the workpiece. This creates an electrical charge on the workpiece. Contaminant particles on the workpiece are released and/or repelled by the electrical charge and are carried away in the liquid layer. The liquid layer is optionally continuously replenished with fresh liquid. The liquid layer may be thinned out in a localized aerosol impingement area, via a jet of gas, to allow the electrical charge of the aerosol to better collect on or near the surface of the workpiece.

### BACKGROUND OF THE INVENTION

Semiconductor devices are essential in modern life. Virtually all of today's electronic products could not exist without semiconductor devices. These products include computers, cell phones and communication devices, consumer electronics, medical devices, military equipment, and many other products. Many of these electronic products are used by virtually everyone in the United States on a daily basis.

Semiconductor devices are manufactured by performing many separate steps on substrates or wafers. These steps include polishing, photolithography, coating, metal plating, etching, etc. Cleaning is also very important in manufacturing semiconductor devices. Since the devices are microscopic, they can very easily be damaged or destroyed by even tiny particles of dust or metal, or from residue of process liquids or vapors, fingerprints, etc. Cleaning removes these contaminants or prevents or reduces creation of contaminants in the first place.

Cleaning solutions or chemistries have been applied in various ways, including static immersion, recirculating immersion, aerosols, vapors, and by spraying. These cleaning chemistries are often aqueous based, and may include inorganic components including sulfuric acid, hydrochloric acid (HCl), hydrofluoric acid (HF), ammonium hydroxide, hydrogen peroxide, ozone, hydrogen, or other components. A water rinse, generally using de-ionized water (DI), is typically carried out after the chemical cleaning steps. The rinse may be done with pure water, or with chemical additives such as HF or HCl or another compound.

Historically, along with the chemical cleaning effects provided by these types of cleaning chemistries, semiconductor cleaning techniques have also included physical removal processes, such as tank agitation, spraying, and acoustic agitation. In addition, temperature, pressure, and electromagnetic radiation have also been used in semiconductor cleaning, typically in combination with other techniques.

These processes have been successfully coupled with specific chemistries (often using bases in solution to increase the pH of the solution, to improve particle removal). Electrical charging of particles has been recognized as an important factor in cleaning semiconductor materials. The electrical attraction of a given particle in a given environment, to a specific surface, is described in terms of zeta potential. Particle removal can be improved during cleaning by creating a favorable zeta potential, i.e., by creating an environment where attractive electrical forces between a wafer or workpiece surface to be cleaned, and a contaminant particle, are minimized. Numerous studies have concluded that contaminant particles are primarily held onto the wafer surfaces by electrical charge interactions, rather than by physical effects. The cleaning techniques used in the past that focus solely on chemical and physical methods, may therefore fail to counteract the primary adhesion forces which must be overcome to remove contaminant particles. However, while removing the electrical charge based attraction forces is important, it must be done carefully. Applying too much of an electrical charge can damage or destroy semiconductor devices. Consequently, obtaining improved cleaning performance presents difficult engineering challenges.

The trend in the semiconductor industry (including similar devices such as micro electromechanical systems, media storage, etc.) is to continue towards ever smaller devices. Consequently, there is a corresponding need for cleaning techniques to remove or avoid ever smaller contaminant particles. The semiconductor industry also continues to strive for ways to reduce the process time of cleaning steps, to reduce the consumption of materials used in the cleaning process, and to achieve improved cleaning performance.

Accordingly, improved methods and systems for cleaning semiconductor wafers and similar substrates are needed.

### SUMMARY OF THE INVENTION

A new cleaning technology with major advantages has now been developed. In a first aspect of the invention, in a method for cleaning a workpiece, the workpiece is placed into a processing chamber. An electrically charged aerosol of liquid droplets is formed by an aerosol generator. The aerosol generator may be in the chamber, or outside of the chamber, with the aerosol then moved into the chamber. The electrically charged aerosol droplets are directed to or conveyed to the workpiece. This creates an electrical charge on the workpiece. The electrical charge repels contaminant particles from the surface of the workpiece. A liquid film is advantageously maintained on the workpiece surface. Contaminant particles repelled from the workpiece surface are entrained in and carried away by the liquid film. Cleaning performance is improved.

In a second aspect, the liquid layer is thinned out or displaced at the aerosol impingement or target area. Thinning may be achieved by directing a jet of gas at the target area. Thinning the liquid layer allows the charge of the aerosol droplets to collect at or closer to the surface of the workpiece.

In a third aspect, the method may include the additional step of spinning the workpiece. Spinning may be used to maintain the liquid film across the workpiece surface, and to maintain a desired thickness of the liquid film. Spinning can also be used to maintain a flow of fresh liquid onto and off of the workpiece, to carry away contaminants, and to reduce re-deposition of contaminants. The methods described here can of course also be performed on a stationery workpiece. Alternatively, other types of relative movement between the aerosol generator and the workpiece may be used.

In a fourth aspect of the invention, the aerosol generator includes at least one nozzle. The electrically charged aerosol droplets are created by moving or pumping a liquid through the nozzle. The nozzle can be fixed in position relative to the workpiece, or it can be moving relative to the workpiece movement. The nozzle may be an electrostatic nozzle, an electrohydrodynamic nozzle, a piezoelectric nozzle; or an ultra-sonic or mega-sonic nozzle. Alternatively, the aerosol generator may operate by blending the liquid with a gas jet, in either an aspiration or an atomization mode. The aerosol generator may also form the aerosol droplets at least in part via use of an electric field.

In a fifth aspect of the invention, the aerosol droplets are moved through an electric field, after they are formed, to either focus or disperse the droplets. The electric field may be an electrically charged ring or other electrode.

Other and further objects and advantages will appear in the following detailed description. The various alternative embodiments shown are examples of how the present systems and methods may be made and used. Many other alternative designs can of course also be used, within the scope of the invention. The features and elements shown and described in one embodiment can of course be used equally as well in other embodiments. The invention resides as well in sub-combinations and sub-systems of the elements described. The elements that are essential to the invention are described in the claims. Many other non-essential elements are of course also described in the detailed description below.

### BRIEF DESCRIPTION OF THE DRAWINGS

The drawings are provided to illustrate concepts of the invention, which can be used in manufacturing machines and performing the methods of the invention. The drawings are not intended as a definition of the invention. The orientation, position, spacing, size, and interaction of the elements shown in the drawings can be changed, while still practicing the invention and achieving its advantages.

FIG. 1 is schematic diagram of illustrating a first concept of the invention.

FIG. 2 is schematic diagram of illustrating a second concept of the invention, using swing arms.

FIG. 3 is schematic diagram of illustrating a third concept of the invention.

### DETAILED DESCRIPTION OF THE EMBODIMENTS

The systems and methods described here may be used to treat workpieces such as semiconductor wafers, flat panel displays, hard disk media, CD glass, memory and optical media, MEMS devices, and various other substrates on which micro-electronic, micro-mechanical, or micro-electromechanical devices are or can be formed. These are collectively referred to here as workpieces or wafers. Descriptions here of semiconductors, or the semiconductor industry or manufacturing, also include the workpieces listed above, and their equivalents.

In a cleaning process, a workpiece is placed into a processing chamber. The wafer may be either stationary or it may be moving during the process. An electrically charged aerosol is formed by an aerosol generator. A liquid layer is provided on the workpiece. At the target cleaning or aerosol delivery area, the liquid layer is thinned or reduced down to a microscopic film. The aerosol is propelled to and/or through the liquid film at the target cleaning area. Droplets or particles of the charged aerosol impart an electrical charge at or near the workpiece surface. This electrical charge repels contaminant particles, helping to clean the workpiece. Most contaminant particles are negatively charged. Consequently, in general, the aerosol is provided with a negative charge.

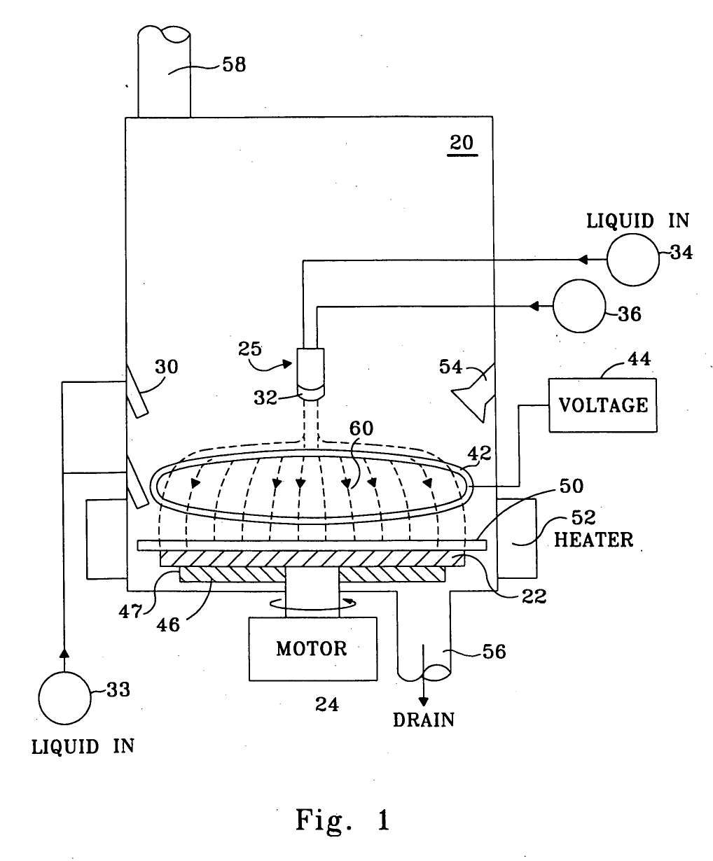

Turning now to FIG. 1, a rotor 22 supports a wafer or workpiece 50 within a process or cleaning chamber 20. A motor 24 spins the rotor 22. A sonic transducer 46, such as an ultrasonic or megasonic transducer is optionally attached to the rotor 22, to impart sonic energy to the workpiece 50. A conduction heater 47 is also optionally attached to the rotor 22, to heat the workpiece 50 via conduction through the rotor. Chamber heaters 52 may also be provided, inside or outside of the chamber 20, to heat the chamber and thereby indirectly heat the workpiece 50. One or more electromagnetic radiation sources 54, if used, are positioned to irradiate the workpiece. The radiation source 54 may be an ultraviolet or infrared lamp.

One or more spray nozzles orifices or outlets 30 in the chamber 20 are supplied with liquid from a liquid or gas source 33, and are positioned to spray a liquid or a gas onto the workpiece. A gas/vapor exhaust opening 58 is provided near a high point in the chamber 20. The exhaust opening 58 connects with a fab or factory exhaust line, for carrying exhaust gases or vapors out of the chamber. A liquid drain opening 56 is provided near a low point of the chamber 20 and connects into a factory drain line, or to a recirculation line, for draining liquid from the chamber.

An aerosol generator 25 in the chamber 20 is connected to a liquid source 34. The liquid contained in the liquid source (e.g., a tank, reservoir or factory supply) may be the same as, or different from, the liquid in the source 33. The aerosol generator may be fixed in position within the chamber 20, or it may be movable in a range of motions, to better deliver aerosol to the workpiece. Alternatively, the workpiece can be moving (spinning and/or moving linearly), or both the aerosol generator and the workpiece may be moving. The aerosol generator 25 is typically an aerosolizing nozzle or spray head, such as an electrostatic nozzle, a piezoelectric nozzle, an ultrasonic or megasonic nozzle, or an electrohydrodynamic atomization nozzle 32. Other devices may also be used as an aerosol generator 25, including non-nozzle or non-spraying devices, as long as they can create an aerosol 60. The term “aerosol” here means a suspension or dispersion of fine particles or droplets of a liquid in a gas or vapor. In general, the aerosol droplets have a mean size distribution of 1-50, 2-40, or 4-25 or 30 microns. Another way to create the aerosol is by blending a gas jet with a stream of liquid in either aspiration or atomization mode. Using any of these or equivalent techniques, an aerosol is formed with the aerosol droplets or particles having an electrical charge. One, two, or more aerosol generators may be used, in any embodiment.

The aerosol 60 is moved or directed to the workpiece. This movement can be achieved via spraying (fluid force propulsion), via a gas jet, via electrical repulsive forces, or in other ways. Combinations of them may also be used. For example, a nozzle may be used to form the aerosol droplets, to charge the droplets, and also to propel the droplets to the workpiece. A gas stream from a gas source 36 can be used with the nozzle, to insure that the aerosol flow has sufficient momentum to reach the workpiece. Regardless of the propulsion method used, the charged aerosol contacts the workpiece, or liquid layer on the workpiece. The electrical charge of the aerosol droplets accumulates on, at, or near the workpiece surface. This imparts an electrical charge on, at, or adjacent to the surface. The polarity of the charge on the aerosol particles is selected to be the same as the charge of contaminant particles on the workpiece surface. As a result, the electrical charge on the workpiece surface accumulated from the charged aerosol particles repels the contaminant particles. This repulsion force tends to release particles sticking to the surface, and repels them away from the workpiece surface. The aerosol droplets are used as charge carriers, to carrier an electrical charge onto the workpiece surface. The term workpiece surface here means either the surface of the workpiece itself, or the surface of a layer, film, or coating on the workpiece, if present.

FIG. 1 shows a design having a ring or electrode 42 in the chamber. A voltage source 44 electrically charges the ring 42. By adjusting the polarity, charge, and position of the ring 42, the flow or stream of aerosol from the aerosol generator 25 can be focused or directed. If the ring is charged with a polarity opposite to the polarity of the charge imparted to the aerosol droplets, the ring will attract and therefore disperse the aerosol droplets. On the other hand, if the ring and the droplets have the same polarity, then the ring will repel the aerosol droplets, tending to focus or funnel down the aerosol stream, as the stream moves through the ring to the workpiece.

The design in FIG. 1 can also be used without any ring 42. Alternatively, multiple rings 42 can be used, either spaced apart, or brought together, to form a focusing shroud or tunnel, rather than a discrete ring. Non-circular and non-planar rings may also be used. Moreover, a simple electrode of any shape (e.g., a rod, plate, cylinder, cone, screen, etc.), may be used in place of the ring.

Regardless of whether any ring or electrode 42 is used, for certain applications, it may be advantageous to switch the polarity of the charge of the aerosol during the cleaning process, either permanently (i.e., for the duration of the cleaning process), or in an alternating, or a pulsating manner. The polarity and voltage of the charge of the aerosol, and other parameters, such as temperature, flow pressure or velocity, nozzle configuration, etc., can be adjusted, and varied, to adjust the shape, trajectory, charge, and momentum of the aerosol stream.

Steam may also be used to create the charged aerosol. The steam may be accelerated through an electrically charging nozzle, as described above relative to liquid. The steam may also be conducted through a charge exchanging material such as Teflon (fluorine resins), charging the steam via electron exchange. The steam may also be charged by moving it through an electric field.

In the design of FIG. 1, during processing or cleaning, a liquid 33 such as DI water, from the source 33 is applied to the workpiece surface via nozzles or openings 30. The motor 24 spins the rotor 22 and the workpiece 50. Centrifugal force forms the liquid 33 into a layer 62. For most applications, liquid 33 is continuously delivered onto the workpiece 50, and liquid also continuously flows off the edges of the workpiece as runoff 64. As a result, a layer of substantially fresh liquid is maintained on the workpiece surface. The liquid 33 can be delivered towards the center of the workpiece (by spraying, dripping, bulk transfer pumping, etc.). The liquid then flows radially outwardly due to centrifugal force, until it reaches the workpiece edge, where it flows off as runoff 64, or is flung off the workpiece. Maintaining a layer of liquid 60 on the workpiece surface minimizes the potential for released contaminant particles to redeposit or re-adhere onto the workpiece surface. The liquid layer also prevents inadvertent premature drying and/or spotting. Maintaining a flow of fresh liquid on or across the workpiece surface helps to carry released or repelled contaminant particles off of the workpiece.

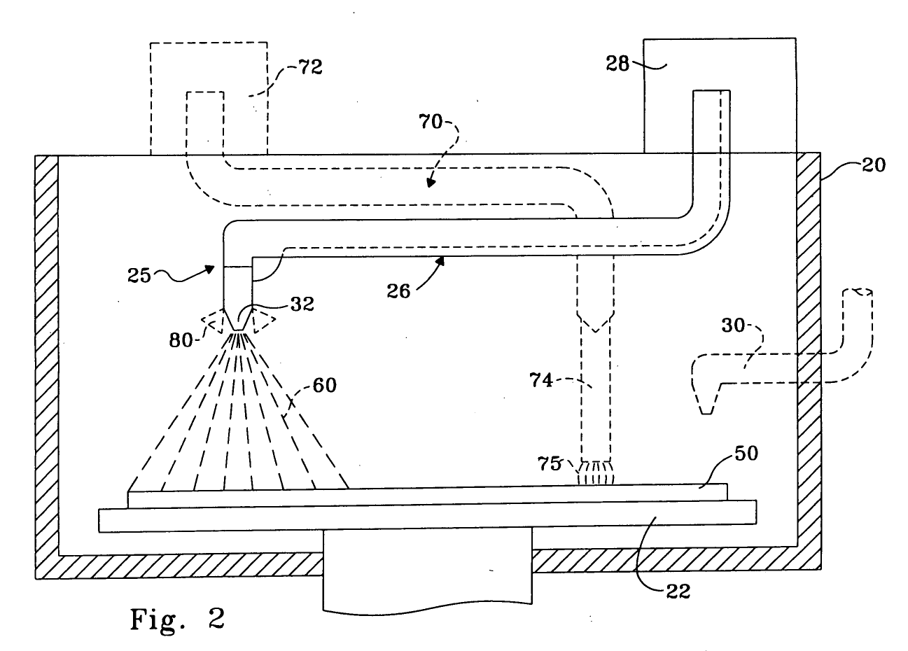

FIG. 2 shows an alternative design having a reciprocating spray arm 26. The aerosol generator is located on the spray arm 26. A motor 28 drives the spray arm 26 back and forth, in an arc across the spinning workpiece 50. This allows all areas of the workpiece surface to be substantially uniformly contacted by the aerosol. As shown in dotted lines in FIG. 2, a second or rinse spray arm 70 is optionally provided. The second arm typically is used to deliver a rinse liquid 75 onto the workpiece. A motor 72 drives the second arm 70, also in a back and forth movement. An extension tube 74 may be used to gently release a flow of rinse liquid 75 onto the workpiece surface. The gentle release of rinse liquid avoids splattering which could interfere with operation of the aerosol delivery. The rinse function of the second arm 70 can be included in the first arm, to provide a single arm design having both aerosol and rinse nozzles or openings on one arm.

Separate gas jet nozzles or orifices 80 may be provided on the arm 26. These nozzles, if used, spray or jet out gas, such as nitrogen, to thin out the liquid layer at the area where the aerosol impinges onto the workpiece surface. Other techniques may also be used to temporarily thin out or displace the liquid layer at the target area of aerosol impingement. Temporarily removing, thinning or displacing the liquid layer allows the aerosol to more directly contact near the actual wafer surface, rather than contacting the liquid film or layer on the workpiece surface. As the aerosol stream and the impingement area move across the workpiece, the liquid layer closes up behind it. This reduces the potential for re-adhesion or re-depostion of contaminant particles. In general, a thin layer of liquid should remain over the aerosol impingement area, to avoid premature drying and water spots.

In most cases, the liquid layer works well if it is uniform and quiet. Consequently, relatively low flow rates of about 100-300 or 150-250 cc of rinse liquid/minute are typically used. The liquid layer will generally be about 0.5 to 5 mm, and more typically 1-3 or 1-4 mm thick. The actual thickness will of course vary depending on where and how the liquid is delivered, spin speed, where on the workpiece the measurement is made, and on other factors as well.

The positions, spacing and movement of one or both arms may be adjustable. Typically, the nozzle 32 will be spaced apart from the wafer surface by about 0.3-5 cm, or 0.4-4 cm, or 0.5-2 or 3 cm. The spacing shown in the drawings is exaggerated for purpose of illustration. Additional nozzles, openings or orifices may be provided on the first or second arms, to deliver other gases or liquids. For example, the second arm may have one nozzle supplying rinse liquid, and another supplying IPA for surface tension assisted drying.

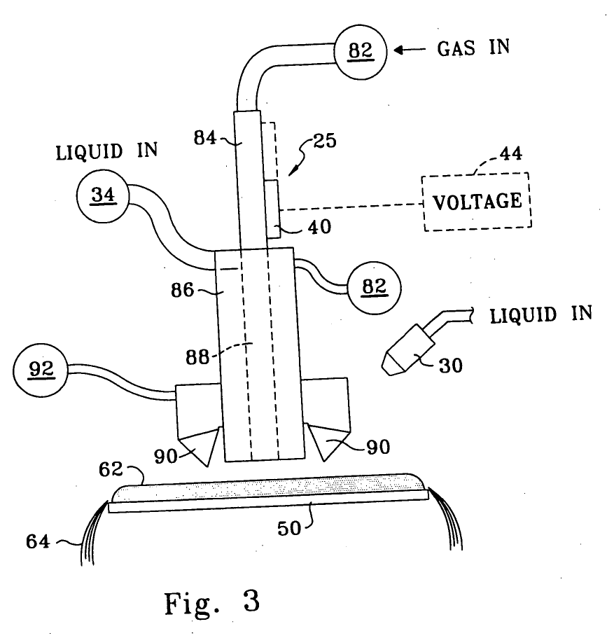

In the design shown in FIG. 3, an alternative aerosol generator 25 has a gas from a gas source 82 flowing to a gas nozzle 84. Electrodes 40 on or in the nozzle 84 are connected to a voltage supply 44. As gas flows through the nozzle 84, it becomes electrically charged. Liquid from a source 34 is introduced into the nozzle 84, mixes with the gas, and forms a charged aerosol. Additional or other gas (e.g., nitrogen) flows directly into a gas shroud or tube 86. The gas shroud conducts the gas to a position just above the liquid layer on the workpiece. Gas flowing out of the shroud displaces or thins the liquid layer down to a microscopic film, in a circular target area under the shroud. The shroud inside diameter, and the target area are typically round, with a diameter of 1-5 or 2-3 cm. The aerosol flows through an internal central tube 88 and impinges or impacts against the liquid film. The electrical charge of the aerosol transfer to and/or through the liquid film and releases and/or repels contaminant particles. In most cases, better overall performance is achieved by maintaining a liquid layer on the workpiece. The liquid layer helps to avoid water marks and drying spots. However, in some uses, if the aerosol distribution is well controlled, the liquid layer may be omitted. As shown in FIG. 3, flood or target area liquid nozzles or outlets 90 are attached to or otherwise track with movement of aerosol generator 25. Liquid from a reservoir or source 92 (which may be the same or different from the liquid 34) is supplied to the nozzles 90. The nozzles 90 deliver liquid 92 onto the workpiece around the target area. Multiple nozzles 90, or an annular manifold having multiple nozzles or outlets 90, may be used.

In most cases, the aerosol droplets are propelled with sufficient momentum so that they impact the workpiece surface and also provide a physical cleaning effect. That is the impact of droplets acts to physically remove contaminant particles, while the electrical charge acts to release and repel contaminant particles.

In general, gravity forces are largely insignificant here in comparison to other forces, such as inertial, centrifugal or viscous forces. Consequently, the up/down orientation of the elements described can be varied as desired. For example, the systems shown in the Figures, with minor changes, could be operated upside down, or turned on one side, without affecting the processing results. While spinning the workpiece has certain advantages, it is not essential. The workpiece may remain entirely stationary, while the aerosol generator moves relative to the workpiece.

Specific gasses and liquid may be used for specific cleaning applications. Some liquids such as HCI and HF, are known to be effective at removing metal contaminants. These are typically not found as particles on the surface to be cleaned, but are dispersed as molecular and ionic contaminants. The charged aerosol will have little effect on these types of contaminants, but inclusion of other chemical species such as HF or HCI will have the simultaneous beneficial effect of removing metal contaminants while the charged aerosol will remove particles.

Chemistries such as ammonium hydoxide are known to elevate the pH and generate a favorable zeta potential to assist with particle removal in conjunction with the charged aerosol. In addition, specific gasses may be used in conjunction with the charged aerosol. These may be either dissolved in the liquid or used as a carrier for the aerosol as or after it is generated. Ozone may be used in this manner to provide an organic cleaning solution when applied in conjunction with water. Hydrogen may be used to create a reducing environment for the removal of metal ion contamination. Even gasses considered to be “inert” such as nitrogen may be used to impart a favorable charge to the wafer surface and particles which will result in an electronic repulsion to prevent or reduce particle re-adhesion to the surface being cleaned.

Other gasses may also find specific application, ranging from HF to provide silicon dioxide etch capability to ammonia to elevate the pH for particle removal capability. Various gasses may be used in conjunction with liquids, (both aqueous and non-aqueous) to achieve a specific cleaning result.

The present methods can be used with more conventional cleaning techniques including spray streams, sonic (including megasonic) agitation, aerosol delivery and electromagnetic spectra energy wherein the surface to be cleaned would be irradiated with energy to enhance cleaning performance.

The methods described here can be used at any temperature, including the use of superheated steam. Subambient processing is also feasible, although higher temperatures above ambient where gas solubility decreases significantly have more general use. Thus gasses with low solubility can still be delivered to the wafer surface in concentrations sufficient to provide a cleaning benefit.

Surfaces which have been cleaned by the application of the solution may be protected from recontamination by leaving a liquid film on them and/or by providing a dynamic gas flow in the process chamber which will carry contaminants away in the exhaust stream rather than allowing them to settle on the wafer surface.

Conventional rinsing and drying of substrates may be performed in the same chamber as the cleaning steps, or may be performed in a separate area. These would include spin drying as well as surface tension gradient drying.

Thus, several designs have been shown and described. Various changes and substitutions can of course be made without departing from the spirit and scope of the invention. The invention, therefore, should not be limited, except to the following claims and their equivalents.

1. A method for processing a workpiece, comprising:
placing the workpiece into a processing chamber;
forming electrically charged aerosol droplets of a liquid;
directing the electrically charged aerosol droplets to the workpiece;
creating an electrical charge on the surface of the workpiece by allowing the aerosol droplets to collect on the surface of the workpiece; and
with the electrical charge repelling contaminant particles from the surface of the workpiece.

2. The method of claim 1 further comprising maintaining a liquid layer on the workpiece surface and entraining contaminant particles in the liquid layer.

3. The method of claim 2 further comprising thinning the liquid layer at a target area, and directing the aerosol to the target area.

4. The method of claim 1 further comprising directing the electrically charged aerosol via at least one nozzle, and moving the nozzle relative to the workpiece.

5. (canceled)

6. (canceled)

7. The method of claim 1 further comprising directing the electrically charged aerosol via at least one nozzle, spinning the workpiece about a spin axis, and moving the nozzle relative to the spin axis.

8. The method of claim 4 wherein the nozzle comprises a member selected from the group consisting of an electrostatic nozzle, a piezoelectric nozzle; and an ultra-sonic or mega-sonic nozzle.

9. The method of claim 1 wherein the aerosol droplets are formed by blending the liquid with a gas jet.

10. (canceled)

11. The method of claim 1 further including forming the aerosol droplets at least in part via use of an electric field.

12. The method of claim 1 further including passing a stream of the liquid through an electric field.

13. (canceled)

14. The method of claim 1 further comprising focusing aerosol droplets by passing them through a focusing ring having an electrical charge of the same polarity as the aerosol droplets.

15. (canceled)

16. The method of claim 1 further comprising dispersing the aerosol droplets by passing them through a focusing ring having an electrical charge of polarity opposite to the polarity of the aerosol droplets.

17. The method of claim 1 further including directing the aerosol droplets at least in part via a stream of gas.

18. (canceled)

19. The method of claim 2 wherein the liquid film is maintained on the surface of the workpiece by spraying liquid onto the workpiece.

20. (canceled)

21. (canceled)

22. (canceled)

23. (canceled)

24. The method of claim 1 further including providing sonic energy to the workpiece.

25. The method of claim 1 further including irradiating the workpiece with infrared or UV light.

26. The method of claim 1 further including heating the workpiece.

27. (canceled)

28. The method of claim 2 further comprising the step of maintaining a substantially continuous flow of fresh liquid onto the workpiece, to carry away released contaminants and prevent redeposition.

29. The method of claim 1 further including drying the workpiece via surface tension gradient drying, or by using a heated gas.

30. A method for processing a workpiece, comprising:
placing the workpiece into a processing chamber;
forming an electrically charged spray or jet of steam;
directing the electrically charged steam to the workpiece;
creating an electrical charge on the surface of the workpiece by allowing at least some steam to condense on the surface of the workpiece; and
repelling contaminant particles from the surface of the workpiece via the electrical charge created on the surface of the workpiece.

31. (canceled)

32. (canceled)

33. The method of claim 32 further comprising thinning the liquid layer at the target via a jet of gas.

34. The method of claim 32 further comprising applying a liquid onto the workpiece around the target area.

35. A system for cleaning a workpiece, comprising:
means for forming electrically charged aerosol droplets;
means for providing a liquid layer on a surface of the workpiece;
means for reducing the thickness of the liquid layer at a target area on the workpiece; and
means for propelling the electrically charged aerosol droplets at the target area.

36. A system for cleaning a workpiece, comprising:
a chamber;
a workpiece holder in the chamber;
an aerosol generator in the chamber;
a liquid supply system for supplying liquid onto the workpiece in the chamber; and
a gas shroud in the chamber moveable relative to the workpiece holder; and
a gas supply connecting to the gas shroud.

37. The system of claim 36 wherein the workpiece holder comprises a rotor.

38. The system of claim 36 wherein the aerosol generator comprises an electrostatic nozzle, a piezoelectric nozzle; or an ultra-sonic or mega-sonic nozzle.

39. The system of claim 36 further including liquid delivery outlets or nozzles adjacent to the gas shroud.

40. (canceled)

41. (canceled)
